(19) United States
(12) Patent Application Publication
(10) Pub. No.: US 2006/0191015 A1
(43) Pub. Date: Aug. 24, 2006

(54) Copy-protecting applications in a digital broadcasting system

(76) Inventors: Jonathan G. Foster, Bradford-on-Avon (GB); Immo Benjes, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/566,892

(22) PCT Filed: Jul. 28, 2004
(86) PCT No.: PCT/IB04/02572

§ 371 Date: Feb. 1, 2006

(30) Foreign Application Priority Data
Aug. 2, 2003 (GB) 0318197.1

(51) Int. Cl. H04L 9/32

(52) U.S. Cl. 726/27

(57) ABSTRACT

A digital broadcasting system, such as DVB-MHP, transmits applications (320) in encrypted form to terminals (60). Details about the application, such as encryption method, cost and payment details are transmitted to terminals. Terminals use an interaction channel (85) to obtain authorization to access the application (320) from an authorizing entity (55). Authorized terminals receive a key (215) which can be used to decrypt the encrypted application (320). The functionality to authorize the terminal can reside on the terminal (60) or it can form part of a launcher application (310, FIG. 5) which is received by the terminal.

This invention relates to digital broadcasting systems and to the delivery of applications to terminals in such systems. The invention is particularly applicable to the Digital Video Broadcasting Multimedia Home Plafform (DVB-MHP) and similar systems.

Digital Video Broadcasting (DVB) systems were originally developed to deliver audio and video material. In recent years there has been increasing interest in delivering applications which can be downloaded and executed by terminals. The Digital Video Broadcasting Multimedia Home Plafform (DVB-MHP) is a result of efforts to harmonise standards for multimedia set top boxes. It is an open, published, standard for interactive digital television. DVB-MHP, or simply MHP, defines a generic interface between interactive digital applications and the terminals which execute those applications. MHP standards, such as ETSI TS 101 812 V1.3.1, can be viewed at www.etsi.org. Version 1.0.3 of the MHP standard supports freely downloadable applications called ‘Xlets’. Digital Video Broadcasting Globally Executable MHP (DVB-GEM), set out in ETSI TS 102 819, also supports downloadable applications.

Some broadcasters choose to encrypt an entire broadcast stream using a conditional access (CA) system so as to restrict access to content, such as broadcast channels or applications, only to those who have subscribed to their services. While this has proved to offer a high degree of protection to piracy of the content, it requires dedicated descrambling hardware at the user's set-top box. Viewers need either a special set-top box that includes the CA system, or a set-top box with a slot which conforms to the DVB Common Interface (DVB-CI) and a CI-module containing the CA system. Viewers also need a smartcard that identifies them, and the broadcaster needs to keep a central database of authorized smartcards. Many broadcasters use their own bespoke encryption algorithms for the CA system. Realistically, only broadcasters who charge a monthly subscription fee can afford to set up the infrastructure required for a CA system. In view of the above, many broadcasters have chosen not to encrypt the entire transport stream in this manner.

There is interest in delivering pay-per-use applications, such as games, to user terminals as this can generate additional revenue for a broadcaster. However, the current MHP standards do not include support for encrypted applications. Without the ability to encrypt applications, and without a CA system, any applications delivered to user terminals are vulnerable to piracy. Indeed, it is already possible to obtain equipment which can ‘grab’ the entire contents of a file system which is broadcast as part of the broadcast stream, including the code for any applications, and save this to a hard disk.

Many MHP applications are obfuscated to make them more difficult for them to be reverse engineered. This means that the code is processed so that descriptive labels are removed or renamed to less descriptive labels. While this makes it more difficult for a hacker to modify operation of the application, it does not prevent applications from being illegally stored or executed.

The present invention seeks to provide a way of delivering encrypted applications to terminals.

Accordingly, a first aspect of the present invention provides a method of receiving an encrypted application at a terminal in a digital broadcasting system, the terminal having access to an interaction channel which can carry signalling to an external party, the method comprising the steps of:

receiving details about an encrypted application;

authorizing the terminal to access the application by sending an authorization request over the interaction channel to an authorizing entity;

receiving a key over the interaction channel in response to being authorized;

receiving the encrypted application;

decrypting the encrypted application using the received key.

Some of the advantages which arise from this are that users do not have to subscribe to a service; there is no need for subscription cards, a conditional access (CA) system or a CA module at the terminal. Users can simply pay for whatever application they desire without an ongoing subscription commitment, and multiple application providers can offer applications in this way without the problem of a user needing multiple bespoke CA modules in their terminal. It is not necessary for there to be a single authorization entity which handles the transactions and thus no user data has to be shared between application providers. A variety of encryption/decryption algorithms, key lengths and payment systems can be easily accommodated.

The steps of arranging to authorize the terminal and/or decrypting the application can be performed by a launcher application which is received by the terminal. Preferably, the launcher application is broadcast in an unencrypted form. Where a launcher application is used, the encrypted main application may be delivered via the same or a different delivery channel to the launcher application.

A preferred alternative to using a launcher application is to incorporate the functionality of the launcher application into the terminal itself. The functionality can be implemented in software, hardware or a combination of these. Accordingly, further aspects of the invention provide a control apparatus for a terminal in a digital broadcasting system, software for controlling operation of a terminal and a terminal incorporating the control apparatus or software. The software can be installed on the terminal at the time of manufacture or it can be installed onto an existing terminal at a later date as an upgrade. The software can be stored on an electronic memory device, hard disk, optical disk or other machine-readable storage medium. The software can be delivered on a machine-readable carrier or it can be downloaded directly to the terminal via a network.

Another aspect of the invention provides a method of transmitting an application to a terminal (60) in a digital broadcasting system, the terminal having access to an interaction channel (85) which can carry signalling to an external party (55), the method comprising the steps of:

transmitting details about an encrypted application, including a launcher application (320) which is arranged to authorize the terminal (60) to access the encrypted application (320) by sending an authorization request (314) over the interaction channel (85) to an authorizing entity (55); receive a key (215) over the interaction channel (85) in response to being authorized; and decrypt the application using the key (215); and,

transmitting the encrypted application (320).

A further aspect of the invention provides a method of transmitting an encrypted application to a terminal in a digital broadcasting system in which a conditional access (CA) system is not in use, the method comprising:

transmitting unencrypted details about the encrypted application, the details including one or more of: an encryption method used to encrypt the application; cost of the application; payment details; and,

transmitting the encrypted application.

The invention is particularly applicable as an extension to current versions of the Multimedia Home Platform (MHP), although it has wider application to digital video broadcasting systems. These include:
DVB-GEM (ETSI TS 102 819)=Globally Executable MHP—this is a subset of MHP which is not dependent on DVB-SI;
OCAP=OpenCable Application Platform, the new US cable standard based on GEM;
ATSC-DASE=Advanced Television Systems Committee (ATSC) Digital TV Applications Software Environment (DASE), the US terrestrial standard, currently being rewritten based on GEM; and,
ARIB-AE=ARIB (a Japanese TV standards body) standard B-23 “Application Execution Engine Platform for Digital Broadcasting” (ARIB-AE), based on GEM.

Embodiments of the present invention will now be described, by way of example only, with reference to the accompanying drawings, in which:-

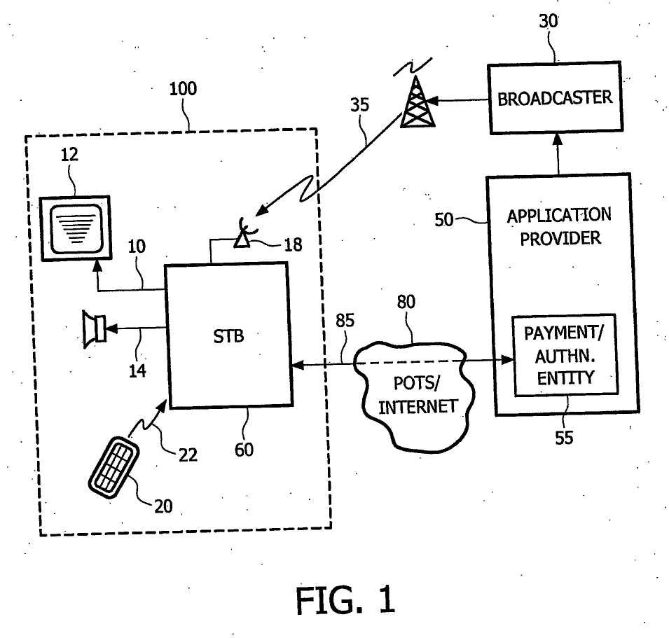

FIG. 1 shows a digital video broadcast (DVB) system embodying the invention;

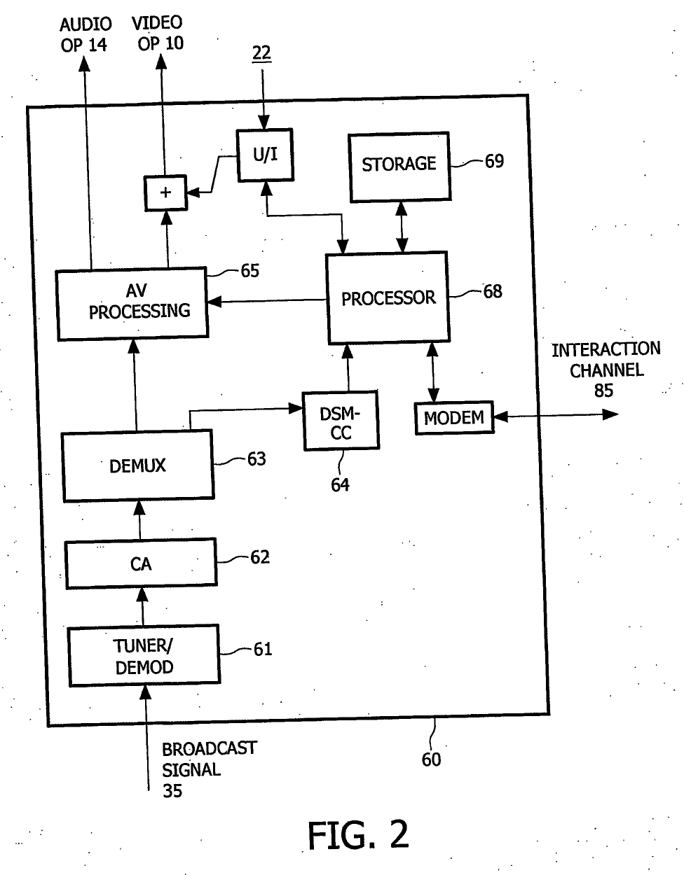

FIG. 2 shows the functional blocks within a subscriber terminal in the system of FIG. 1;

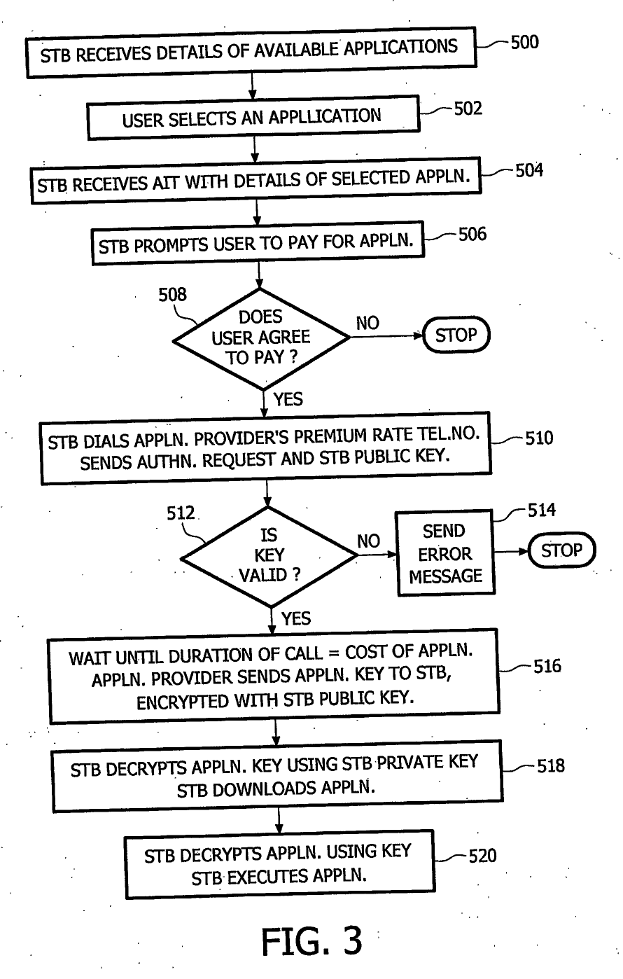

FIG. 3 shows a flow chart of steps in receiving an encrypted application;

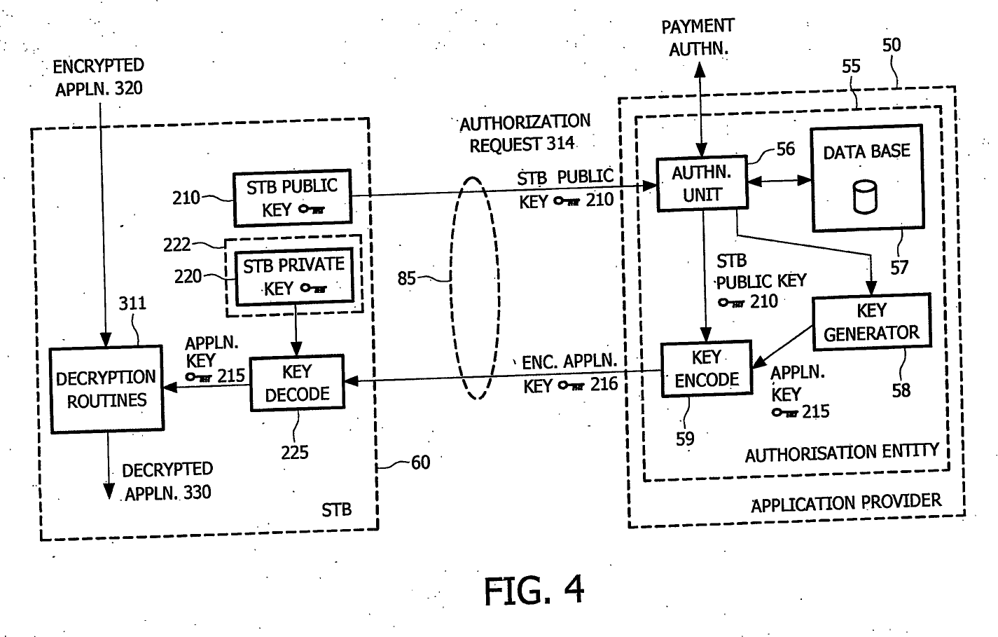

FIG. 4 shows parts of the terminal and authorizing entity of FIG. 1 in more detail; and,

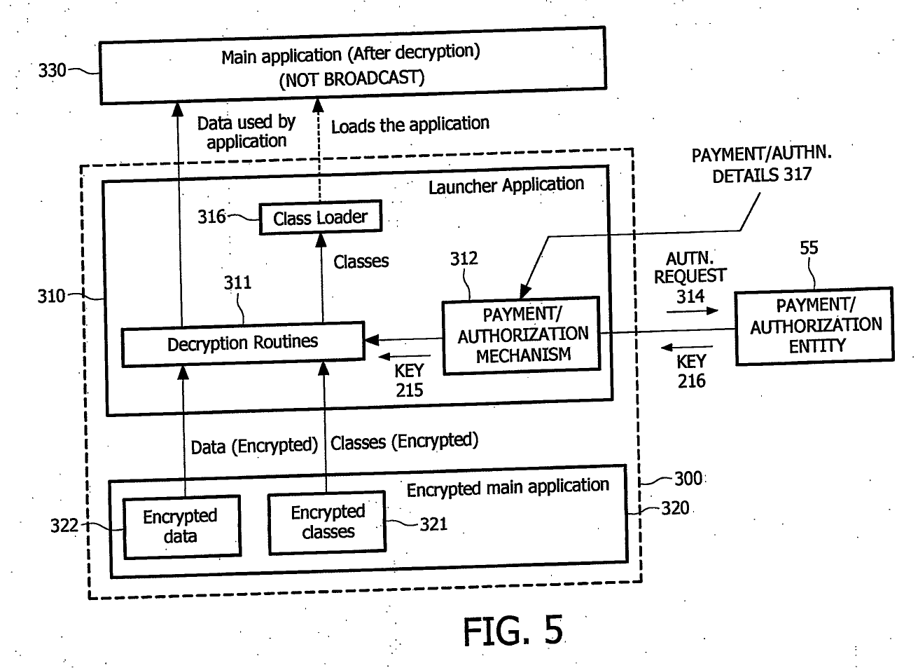

FIG. 5 shows an alternative embodiment of the invention in which a launcher application is downloaded before the encrypted main application.

FIG. 1 shows a digital video broadcasting system for delivering applications to a terminal. Content is generated by a broadcaster 30 and converted into a suitable format for transmission, via a broadcast channel 35, to user premises 100. One such premises 100 is shown. Typically, the broadcast channel 35 is delivered via a satellite although it can be delivered by a terrestrial transmission network, a cable distribution network, or a data network such as the Internet, and the method of delivery is not important to the invention. A terminal (STB) 60 at a user premises receives the broadcast stream, which in this embodiment is via an antenna 18. The broadcast stream delivered via the broadcast channel 35 comprises audio and video content as well as data for supporting various services and applications. In the DVB-MHP specification, data for applications is broadcast as part of a Digital Storage Media—Command and Control (DSM-CC) Object Carousel. This is a repetitively broadcast file system containing the data files for various applications. The format of the broadcast channel for the DVB-MHP system, including the DSM-CC, is set out in ISO/IEC 13818-6, to which the skilled reader is directed for further information.

Applications can be created by the broadcaster 30 or by independent application providers 50 who supply the required files to the broadcaster 30 for insertion in the DSM-CC. Examples of applications include electronic programme guides (EPG), games, quizzes, instructional guides and e-commerce applications such as home banking.

The set top box 60 is also provided with a modem to support an interaction channel 85 to allow the set top box 60 to send data to, and receive data from, external parties. The interaction channel 85 typically uses a conventional telephony network such as POTS. The interaction channel 85 can take the form of: a dial-up connection directly over POTS to an application provider 50, a connection to a gateway of a data network such as the internet, with the connection between the gateway and the application provider 50 being carried across the data network, a combination of a cable back-channel and a connection across a data network (internet) to the application provider, an ADSL or other broadband internet connection, satellite uplink or ISDN line.

Set-top box 60 also includes a user interface with a remote control 20 or keyboard for receiving user inputs and a graphical output for displaying messages which can be overlaid upon the video signal 10 which is fed to television display 12.

An MHP terminal is built around a Java™ Virtual Machine (JVM) and applications are written in Java. The use of Java has the advantage that applications can be written in a common format, with the virtual machine in each type of terminal converting the Java bytecode into a form which is compatible with the particular hardware and software resident on that terminal.

FIG. 2 shows the functional blocks within a typical MHP terminal 60. In a known manner, terminal 60 includes a front end for processing a received broadcast signal 35. This includes a tuner and demodulator 61 for selecting and demodulating a required channel and an optional conditional access unit 62 for descrambling the signal. The resulting digital data stream is demultiplexed 63 into data streams representing audio and video data (typically in MPEG-2 format) and data for applications in the form of the repetitively broadcast DSM-CC Object Carousel 64. The audio and video data can then be further processed 65 to derive suitable output signals 10, 14 for presentation to a user. Once downloaded from the broadcast stream, the application (or several applications) will reside on memory 69 in the terminal and will be executed by microprocessor 68. An application may receive user inputs 22, generate audio and video outputs, and access the interaction channel 85 via an Application Programming Interface (API). Control software for operating the terminal also resides on a memory device. It should be noted that FIG. 2 shows a terminal which is intended to receive signals via a broadcast delivery channel. In other embodiments of the terminal, which are intended to interface with non-broadcast delivery channels, the tuner/demodulator 61 is replaced by a network interface appropriate to the delivery channel. This can be an Internet Protocol (IP)-based delivery channel.

In accordance with this invention, applications are transmitted in encrypted form. There are essentially two ways in which the terminal 60 can be modified to handle encrypted applications.

A first way makes use of an unencrypted launcher application which is downloaded from the broadcast stream 35 in advance of the main application. The launcher application comprises code for causing the terminal to implement the functions of authorizing the terminal to use the application, such as by handling payment for the application, obtaining a decryption key and starting the encrypted application. The use of a launcher application has a disadvantage of exposing functionality via the API.

A second way incorporates functionality of the launcher application into the terminal and broadcast signalling is modified to contain information about the application, such as the cost of the application, the encryption algorithm which has been used and contact details for obtaining the decryption key.

FIGS. 3 and 4 show a first embodiment of the process for downloading an encrypted application from the broadcast stream. In this embodiment the functionality for handling encrypted applications is built into the terminal, i.e. no launcher application is required. FIG. 3 shows a flow chart of the steps of the process and FIG. 4 shows some of the functional blocks in the terminal 60 and application provider 50 and the transfer of cryptographic keys.

Firstly, at step 500, the terminal STB receives details of applications that are available for downloading. This information is carried in the Application Information Table (AIT). The table is transmitted via MPEG sections (in binary form). All fields of the table are specified in the MHP specification. It is preferred that the AIT is modified to include details such as:
the encryption method which has been used to encrypt the application (including key length);
payment methods that can be used and details of how to contact the application provider for authorization, such as a telephone number or server address of the application provider;
information for display to a user, such as the price of the application.

The following is an example of how the AIT can be modified:

| | No. | |
|---|---|---|
| | of | |
| | bits | Comment |
| application_information_section( ) { | | |
| table_id | 8 | |
| section_syntax_indicator | 1 | |
| reserverd_for_future_use | 1 | |
| reserved | 1 | |
| section_length | 12 | |
| test_application_flag | 1 | |
| application_type | 15 | (Field 1 |
| | | discussed below) |
| reserved | 2 | |
| version_number | 5 | |
| current_next_indicator | 1 | |
| section_number | 8 | |
| last_section_number | 8 | |
| reserved_for_future_use | 4 | |
| common_descriptor_length | 12 | |
| for(i=0;i<N;i++){ | | |
| descriptor( ) | | |
| } | | |
| reserved_for_future_use | 4 | |
| application_loop_length | 12 | |
| for(i=0;i<N;i++){ | | (application loop) |
| application_identifier( ) | | |
| application_control_code | 8 | |
| reserved_for_future_use | 4 | (Field 2) |
| application_descriptor_loop_length | 12 | |
| for(j=0;j<N;j++){ | | |
| descriptor( ) | | (Descriptor A) |
| } | | |
| } | | |
| CRC_32 | 32 | |
| } | | |

There are different ways to signal encrypted applications and the information needed to encrypt the applications.

First it is possible to define that the application_type field will contain the information that all the applications in this AIT are encrypted applications. Currently, this field can have the values 0×0001 (DVB-J application) or 0×0002 (DVB-HTML). As this is a 15 bit field the maximum value can be 0×7FFF. One possibility is to use a mask of 0×4000 to identify encrypted applications (all applications in the AIT are encrypted). An encrypted DVB-J application (normal MHP application) would have the application_type 0×4001 (0×0001|0×4000).

Another possibility is to use a bit of the reserved 4 bit (Field 2) in the application loop to identify an encrypted application. Again, there are two ways to signal the encryption information. It can be added to the AIT, such as by defining a descriptor for this at the position labeled above as ‘Descriptor A’. This is not preferred as the AIT must be quite small (less than 1K). That means that more than one AIT needs to be transmitted, each AIT having it's own PID. A descriptor could look like this:

| | | |
|---|---|---|
| application_encryption_descriptor( ) { | | |
| desriptor_tag | 8 | |
| descriptor_length | 8 | |
| encryption_type | 4 | (enum of different |
| | | encryption systems) |
| keylength | 8 | (enum) or 32 (integer) |
| price | 32 | (first 25 bit integer |
| | | value, last 7 bit fraction) |
| for(i=0;i<3;i++){ | | (3 chars e.g. GBR,EUR) |
| char( ) | | |
| } | | |
| reserved | 4 | |
| payment_system_loop | 4 | (number of supported |
| | | payment systems) |
| for(i=0;i<N;i++){ | | |
| payment_system | 4 | (e.g. Premium number, |
| | | Credit card etc) |
| connection_type | 4 | (Dial up, Internet etc) |
| connection_length | 8 | |
| for(j=0;j<N;j++){ | | |
| char( ) | 8 | (Textual locator) |
| } | | |
| } | | |
| } | | |

For a dial up connection, the textual locator would be a telephone number that the modem should dial; for an IP connection the textual locator would be a URL.

A second, preferred, approach is as follows. In the DSM-CC object carousel, specified in the AIT (via a transport_protocol_descriptor) there is either an XML file for each encrypted application (e.g. with the name “organisation_id”.“application_id”-encryption.xml) or one XML file which contains information on all encrypted applications in that object carousel. Such an XML file could look like this:

```
<?xml version=“1.0” encoding=“UTF-8”?>
<!DOCTYPE mhp_application_encryption SYSTEM
“file:/WHEREEVER/encryption.dtd”>
<!-- The organisation_id and the app_id identify the application.
See Alt -->
<application organisation_id=“32” app_id=“3”>
    <appInfo>
    Here is a textual information about the application which can be
presented to the end user
    </appInfo>
    <!--Information about the encryption system used -->
    <encryption type=“XXX”>
        <keylength>1024</keylength>
        <!-- Any other info for the encryption mechanism -->
    </encryption>
    <!--Information about the payment system used -->
    <payment store=“false|true”>
        <price value=“1.00” currency=“EUR”/>
        <!-- How many times or for how many days can the application
be used before it expires -->
    <!-- If only <day> is specified it can be used for n days. If only
use is specified it can be used m times.
          if both day and use is specified it can be used n days or m
times
whatever expires first -->
        <max_use>
            <day>n</day>
            <use>m</use>
        </max_use>
        <!-- <payment_system
name=“CREDIT_CARD|GELD_CARD|PREMIUM_NUMBER|...”> -->
        <payment_system name=“PREMIUM_NUMBER”>
            <telephone>01900886677</telephon>
        </payment_system>
        <payment_system name=“CREDIT_CARD”>
            <!-- payapp is a protocol for the transaction (tbd) -->
            <address>payapp://mhp.provider.com:666</address>
        </payment_system>
    </payment>
</application>
```

The terminal ClassLoader will have two different application classpaths, i.e. the path it searches for classes. It will have the normal classpath (where it finds unencrypted classes) and the encrypted_classpath (where it will find encrypted classes). So, when parsing the AIT, the terminal has to check whether an application is encrypted. If it is encrypted, the classpath specified in one of the descriptors is added to the encrypted_classpath, otherwise it is added to the normal classpath.

The AIT can also include a flag which indicates whether the application can be stored or copied by the terminal. It is preferred that these extensions are standardised so that any terminal can correctly interpret these details.

Next, at step 502, a user selects one of the available applications and initiates the downloading process. The terminal then begins the process of authorizing the terminal to access the application. The action taken by the terminal is determined by the extensions carried in the AIT or XML file. At step 506 terminal 60 displays a message which indicates the cost of the application (carried in the AIT) and asks the user if they agree to pay for the application. If the user does not wish to pay, then an error message can be displayed and nothing further happens. If the user agrees to pay for the application, then the terminal proceeds to step 510 and uses the interaction channel 85 to dial an authorization/payment entity 55 at the application provider 50, sending an authorization request 314. In this example the mechanism for paying for the application is by the terminal dialling a premium rate telephone number.

FIG. 4 shows the exchange of cryptographic keys which takes place between the terminal 60 and the application provider 50. The terminal has a pair of cryptographic keys: a public key 210 and a private key 220. This pair of keys 210, 220 is unique to the terminal and are signed by the manufacturer of the terminal, which in turn is signed by a trusted certificate authority. Certification may be given when the terminal is certified as being compliant with the MHP standard. The private key 220 never leaves the terminal and is never directly visible to applications. The private key 220 may even be stored in tamper-resistant hardware 222 such as Trusted Computing Plafform Alliance (TCPA)/Palladium.

When the terminal 60 first contacts the application provider 50 it sends public key 210. Upon receiving the public key 210, an authorization unit 56 at the authorization entity 55 checks whether this key is valid. The public key 210 can be used to identify the terminal 60. The signature and certificate chain described above are used to ensure that the key 210 originates from an approved MHP terminal. A ‘black list’ of invalid keys 57 can also be consulted. Terminals may be black listed for various reasons, such as when the terminal is known to have been hacked or the terminal with that key has supplied invalid payment details on a previous occasion. If any of these checks indicates that the terminal that sent the key is not authorised, or not compliant, then an error message can be returned at step 514.

If the key is valid, the application provider 50 waits until the duration of the call to the premium rate telephone number equals the price of the requested application (i.e. the user has paid) and instructs key generator 58 to generate an application key 215. This key 215 will decrypt the application that the terminal has requested. It is preferred that the application key 215 is encrypted using the STB public key 210 to derive an encrypted application key 216. The encrypted application key 216 is returned to the terminal 60 over the interaction channel 85.

At step 518 the terminal receives the encrypted application key 216. The terminal decodes 225 the key using its private key 220 to derive the application key 215 once more. The terminal then begins to download the encrypted application 320 from the DSM-CC. At step 520 the application is decrypted using key 215 and the decrypted application 330 can then be executed in the normal manner.

Any standard decryption algorithm can be used, such as Data Encryption Standard (DES), Triple Data Encryption Standard (3DES), Advanced Encryption Standard (AES) and BlowFish. The terminal may support multiple encryption standards or only one.

The application key 215 can either be stored in the terminal 60 for future use or it may be discarded when the application is closed, depending on the type of application. Pay-per-use applications will require a new key on each occasion whereas pay-once applications may use the same key on each occasion. The terminal may not have sufficient permanent storage to be able to store the entire decrypted application. If the encrypted application is being continuously broadcast then the terminal can simply store the key. The next time the user wants to run the application, the application is downloaded again and decrypted again. Since the key required to decrypt the application is already stored at the terminal, the user does not have to pay again. Furthermore, even if the application is cached/stored on a local storage device, the application should be encrypted to prevent hackers from extracting the application from the local storage device. In that event, even if a hacker were to copy the application, it is still encrypted. If the application key is stored in encrypted form (e.g. encrypted by the terminal's public key in the same way as the application key is transmitted across the interaction channel) then there should be no easy way that the application can be decrypted by pirates.

In this example the authorization is achieved by dialling a premium rate telephone number. However, there are various other ways in which the authorization can be achieved. Some possible ways of obtaining authorization are:
the terminal prompts the user for credit card details. Upon receiving the credit card details, the terminal contacts the payment authorization entity 55 at application provider 50, passing the credit card details and public key 210. Authorization unit 56 may need to contact an external organisation to check that the credit card details are valid. If payment is accepted, an encrypted application key 216 is returned from the application provider 50 to the terminal 60 over the interaction channel 85 as before. Where the application provider 50 knows the owner of the terminal, the credit card details can be compared with the details held by the application provider;
the terminal prompts the user for a subscription or club membership number, possibly with a password or PIN. The terminal then contacts the application provider 50 and provides this information and the public key 210. If the user is authorized, an encrypted application key 216 is sent from the application provider 50 to the terminal 60;
the terminal takes payment from a smartcard (e.g. German GeldKarte) which is inserted into a card reader on terminal 60 and then sends public key 210 to the application provider 50 along with a message indicating payment. The encrypted application key 216 is sent from the application provider 50 to the terminal 60.

It will be appreciated that any other means can be used where the terminal contacts the application provider 50 to obtain a key 216, preferably after paying the application provider 50 in some way. It is preferred that application key 215 is sent in an encrypted form, rather than in the clear, to reduce the chance of third parties intercepting the key and distributing it. Encrypting the application key 215 using the STB public key ensures that the terminal owns the certificate that it presents to the application provider 50. An alternative way of securely sending the application key 215 is by use of an authenticated protocol such as the Secure Socket Layer (SSL) protocol. The terminal's certificate can be used as the client certificate.

FIG. 5 shows an alternative embodiment of the invention where a launcher application 310 is transmitted in advance of the encrypted main application 320. In this embodiment, information about the encrypted application is carried in the launcher application rather than the AIT or XML file and the launcher application can create a custom UI (user interface) advertising the encrypted application.

If a launcher application is used an API is required to support the decryption. If the launcher application simply starts an encrypted MHP application it can use a function, such as a static function, on a special class, e.g. public boolean startEncryptedApp(int org_id, int app_id, byte [symbol] key);

The terminal receives the application information from the AIT but the launcher application is responsible for obtaining the application key, which is passed via an array of bytes.

If the launcher application is the main application and simply wants to load encrypted modules (via the Java reflection API) another factory-defined method is required. public static ClassLoader createDecryptionClassLoader(Encryptioninfo info, String [symbol] classpath, byte [symbol] key)

where the class ‘Encryptioninfo’ contains information about the encryption system used, ‘classpath’ is an array of classpaths and ‘key’ is the key).

A further alternative method is: public static ClassLoader createDecryptionClassLoader(DecryptionEngine decryptor, String [symbol] classpath)

This also creates a new ClassLoader but this time a Class which does the actual decryption is passed as an argument. DecryptionEngine will be an interface. Everything the new ClassLoader reads will be first passed to the DecryptionEngine and than read back (decrypted) by the ClassLoader. In this way, an application can transmit its own Decryption Implementation (e.g. when the decryption algorithm in the box is known to be cracked). The key never leaves the application (although the use an encrypted key (see above) might not be possible).

The decryption routines are resident on the box, although it is possible that they could be downloaded. The launcher application instructs the terminal 60 to create a new ClassLoader.

In the above embodiment the authorization entity 55 is shown as being part of the application provider 50. This need not be the case. Authorization entity 55 can be physically separate from the application provider and perform the authorization function on behalf of the application provider 50.

It is preferred that the application (and launcher application, if there is one) are obfuscated to make them more difficult for them to be reverse engineered. This means that the code is processed so that descriptive labels are removed or renamed to less descriptive labels. Thus, even if a hacker were to successfully decrypt the application, they would find it more difficult to modify operation of the application. The use of shorter, non-descriptive labels also helps to reduce the size of the code.

The invention is not limited to the embodiments described herein, which may be modified or varied without departing from the scope of the invention.

1. A method of receiving an encrypted application at a terminal (60) in a digital broadcasting system, the terminal having access to an interaction channel (85) which can carry signalling to an external party (55), the method comprising the steps of:
receiving details about an encrypted application (320);
authorizing the terminal (60) to access the application (320) by sending an authorization request (314) over the interaction channel (85) to an authorizing entity (55);
receiving a key (215) over the interaction channel (85) in response to being authorized;
receiving the encrypted application (320);
decrypting the encrypted application (320) using the received key (215).

2. A method according to claim 1 wherein the step of receiving details about the application comprises receiving a launcher application (310) which is arranged to authorize the terminal.

3. A method according to claim 1 wherein the step of receiving details about the application comprises receiving a launcher application (310) which is arranged to decrypt the application (320).

4. A method according to claim 2 wherein the launcher application (310) is received via a different delivery channel to the encrypted application (320).

5. A method according to claim 1 wherein the step of decrypting the application is performed by an application loader (316).

6. A method according to claim 5 wherein the application loader (316) is a Java ClassLoader.

7. A method according to claim 1 wherein the received details include one or more of: an encryption method used to encrypt the application; cost of the application; payment details.

8. A method according to claim 1 further comprising the step of collecting payment details from a user of the terminal.

9. A method according to claim 1 further comprising the step of collecting payment from a user of the terminal.

10. A method according to claim 1 wherein the terminal has a public/private key pair (210, 220) and the step of contacting an external party (55) comprises sending the public key (210) to the external party (55).

11. A method according to claim 10 further comprising receiving a decryption key (216) from the external party which has been encrypted using the public key (210).

12. A method according to claim 10 wherein the public/private key pair uniquely identify the terminal.

13. A method according to claim 10 wherein the public key is signed by a manufacturer of the terminal.

14. A method according to claim 1 wherein the digital broadcasting system does not use a conditional access (CA) system.

15. A method according to claim 1 wherein the digital broadcasting system is the Multimedia Home Platform (MHP).

16. A control apparatus for a terminal in a digital broadcasting system which is arranged to perform the method according to claim 1.

17. Software for controlling operation of a terminal in the manner according to claim 1.

18. A terminal incorporating the control apparatus according to claim 16.

19. A method of transmitting an application to a terminal (60) in a digital broadcasting system, the terminal having access to an interaction channel (85) which can carry signalling to an external party (55), the method comprising the steps of:
transmitting details about an encrypted application, including a launcher application (320) which is arranged to authorize the terminal (60) to access the encrypted application (320) by sending an authorization request (314) over the interaction channel (85) to an authorizing entity (55); receive a key (215) over the interaction channel (85) in response to being authorized; and decrypt the application using the key (215); and,
transmitting the encrypted application (320).

20. Software for an application for transmission to a terminal in a digital broadcasting system, the terminal having access to an interaction channel (85) which can carry signalling to an external party (55), the application comprising a launcher application (310) comprising code which, when executed by a processor in the terminal (60), causes the processor to perform the steps of:
authorizing the terminal (60) to access an encrypted application (320) by sending an authorization request (314) over the interaction channel (85) to an authorizing entity (55) and to receive a key (215) over the interaction channel (85) in response to being authorized; and,
decrypting the encrypted application using the received key (215).

21. A signal for transmission in a digital broadcasting system, the signal embodying software according to claim 20.

22. A method of transmitting an encrypted application to a terminal in a digital broadcasting system in which a conditional access (CA) system is not in use, the method comprising:
transmitting unencrypted details about the encrypted application, the details including one or more of: an encryption method used to encrypt the application; cost of the application; payment details; and,
transmitting the encrypted application.

23. (canceled)
